(19) United States
(12) Patent Application Publication
(10) Pub. No.: US 2021/0185097 A1
(43) Pub. Date: Jun. 17, 2021

(54) System for Establishing a Session Initiation Protocol Channel with a Push Message

(71) Applicant: T-Mobile USA, Inc., Bellevue, WA (US)

(72) Inventors: Michele Kinsey, Shoreline, WA (US); Jonathan Alexander Pastore, Bellevue, WA (US)

(21) Appl. No.: 16/835,230

(22) Filed: Mar. 30, 2020

Related U.S. Application Data
(60) Provisional application No. 62/948,087, filed on Dec. 13, 2019.

(51) Int. Cl. H04L 29/06; H04L 29/08

(52) U.S. Cl. CPC H04L 65/1069; H04L 65/608; H04L 65/1073; H04L 67/26; H04L 65/1006

(57) ABSTRACT

A system may comprise a Media Control Unit (MCU) for establishing a conference call for a plurality of client devices. The MCU may determine an occurrence of a termination event associated with a first communication channel of the conference call. The MCU may send a first message requesting an indication of whether a BYE message associated with the client device is stored at a gateway and/or a router. The MCU may receive a response including an indication of an absence of the BYE message at the router and/or the gateway. The MCU may determine to send a call message to a Push Notification Server (PNS) instructing the PNS to send a push message to the client device. The push message may include data for establishing a second communication channel for the client device and, in some instances, for rejoining the client device to the conference call.

### CROSS-REFERENCE TO RELATED APPLICATIONS

This application claims priority to, and the benefit of, U.S. Provisional Patent Application No. 62/948,087, filed Dec. 13, 2019 and entitled “A System for Establishing a Session Initiation Protocol Channel with a Push Message,” which is incorporated herein by reference in its entirety.

### BACKGROUND

A telecommunication service provider operating 3rd Generation Partnership Program (3GPP) networks or other networks often provides a variety of services to users of the 3GPP network. For instance, the telecommunication service provider may establish Session Initiation Protocol (SIP) communication channels for voice calls, texts, data transmissions, etc., between various terminal device (e.g., mobile phones) of the network.

In some instances, the telecommunication service provider may facilitate a conference call so that multiple terminal devices (e.g., three or more) may communicate with each other substantially simultaneously. A network node of the 3GPP network may facilitate multiple communication channels between multiple terminal devices for the conference call. The multiple devices may be physically located in different locations during the conference call, and so some communication channels connecting some terminal devices may be stronger or more reliable than other communication channels connecting other terminal devices. In some instances, the conference call may be negatively impacted by a loss of signal (e.g., a loss of wireless connectivity) at one of the terminal devices. When a terminal device leaves the conference call, it may not be clear to the network node facilitating the conference call whether the terminal device left the conference call based on a user input (e.g., intentionally) or based on a loss of signal (e.g., unintentionally). A process for reconnecting the terminal device to the conference call may take multiple minutes as the terminal device re-enters a personal identification number (PIN) and/or other confirmation information to rejoin the conference call, during which time the terminal device is unable to participate in the conference call.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts a schematic diagram of an example system for establishing a Session Initiation Protocol channel with a push message via one or more network nodes.

FIG. 2 depicts a schematic diagram of an example system which may form at least a portion of any systems discussed herein and may include at least a media control unit and one or more communications between the media control unit and other network nodes.

FIG. 3 depicts a schematic diagram of an example system which may form at least a portion of any systems discussed herein and may include at least a client device and one or more communications between the client device and other network nodes.

FIG. 4 depicts a schematic diagram of an example system which may form at least a portion of any systems discussed herein and may include at least a push notification server and one or more communications between the push notification server and other network nodes.

FIG. 5 depicts a schematic diagram of an example system, which may form at least a portion of any systems discussed herein, for establishing a Session Initiation Protocol with a push message based at least in part on determining an occurrence of a site outage.

FIG. 6 depicts a schematic diagram of an example system, which may form at least a portion of any systems discussed herein, for establishing a Session Initiation Protocol with a push message based at least in part on a security setting.

FIG. 7 depicts an example process including one or more example operations that may be performed by any systems discussed herein and may include techniques for determining an occurrence of a termination event related to a first communication channel and establishing a second communication channel with a push message.

### DETAILED DESCRIPTION

Systems, methods, and apparatuses (hereinafter referred to as the “system”) disclosed herein may establish a Session Initiation Protocol (SIP) channel via a push message. For instance, the system may re-establish a communication channel for a client device unintentionally dropped from a conference call. In some examples, the system may provide techniques for determining the occurrence of a site outage at a first network site providing the conference call and rerouting a plurality of client devices participating in the conference call through a second network site. In some instances, the system may change a communication channel of the client device multiple times, for instance, at regular intervals, throughout the conference call such that the probability of a message being intercepted at a particular network node is reduced. Accordingly, in some examples, the system may improve network fault tolerances, site-outage recovery, and/or network security.

The system may include the client device, an Over-the-Top (OTT) Application at the client device, a media control unit (MCU) for providing bridge communications for the conference call, a WebRTC signal gateway for establishing a first communication channel between the client device and the MCU, a WebRTC media gateway for sending media to and from the client device during the conference call, a SIP router for routing messages to and from the MCU and other network nodes, a push notification server (PNS) for sending push messages to the client device, and/or a Global Traffic Manager (GTM) or a Global Server Load Balancer (GSLB) for monitoring network traffic of the network nodes.

In some embodiments, the MCU may establish the conference call by providing bridge communications between the client device and one or more other client devices via a plurality of communication channels. In some examples, the client device may send a first SIP REGISTER message to the MCU via the WebRTC signal gateway and the SIP router to establish a first communication channel with the MCU, so that the client device may communicate with other client devices during the conference call. The first SIP REGISTER message may include confirmation data and/or other conference call setup data for establishing the first communication channel.

In some examples, the MCU (and/or other network nodes) may determine the occurrence of a termination event related to the first communication channel and/or the client device. For instance, the WebRTC signal gateway and the SIP router may share state and the MCU may check a state machine to determine the occurrence of the termination event. In response, the MCU may send a BYE-check SIP message, for instance to the WebRTC signal gateway and/or the SIP router, requesting information indicating whether or not a BYE message associated with the client device is stored at the WebRTC signal gateway and/or the SIP router. The MCU may receive a BYE-check response SIP message, for instance, from the WebRTC signal gateway and/or the SIP router, indicating a presence or an absence of the BYE message at the WebRTC signal gateway and/or the SIP router.

In some examples, the BYE-check response SIP message may include an indication of the absence of the BYE message at the WebRTC signal gateway and/or the SIP router, which may be determined via an API call to the state machine. Based at least in part on the indication, the MCU may determine to send a call message to the PNS instructing the PNS to send a push message to the client device. The push message may include conference call setup data that, upon being received at the OTT application on the client device, may cause the client device to reconnect to the conference call. For instance, the push message may include information similar and/or identical to the first SIP REGISTER message and/or an instruction to send a second SIP REGISTER message (which may be similar to or identical to the first SIP REGISTER message) to the WebRTC signal gateway. Upon receiving the push message, the client device may send the second SIP REGISTER message to the WebRTC signal gateway to establish a second communication channel and rejoin the conference call.

In some instances, the system may determine the occurrence of a site outage associated with a first network site including the WebRTC signal gateway. For instance, the system may determine the occurrence of multiple termination events associated with multiple client devices and, at least partly in response, determine that the multiple termination events are associated with a particular region comprising the first network site. For instance, the multiple termination events may lack associated BYE messages such that the system may determine that the multiple termination events are unintentional. Accordingly, the system may determine to send one or more call messages to the PNS instructing the PNS to send one or more push messages to the multiple client devices. For instance, each client device of the multiple client devices may receive one push message. The multiple push messages may instruct the multiple client devices to send multiple second SIP REGISTER messages to a second WebRTC signal gateway, such that the multiple client devices rejoin the conference call by being rerouted to a second network site including the second WebRTC signal gateway (and/or by omitting the first WebRTC signal gateway that was affected by the site outage). Accordingly, the system may provide fault tolerance for a site-level outage and/or a region-level site outage.

In some embodiments, the MCU may determine to send the call message (e.g., a SIP RE-INVITE or a SIP REFER message) to the PNS instructing the PNS to send the push message based, at least in part, on a security setting stored at the MCU. For instance, the security setting may include a channel cycling schedule that instructs the MCU to send multiple call messages at regular intervals, one or more of the multiple call messages including different WebRTC signal gateway addresses, such that the client device connects to a different WebRTC signal gateway each time it receives a push message corresponding to the one or more call messages. Accordingly, the system may provide a dynamically changing network pathway for the communication channel connecting the client device to the MCU, such that data transmitted between the client device and the MCU (e.g., during the conference call) is more difficult to intercept at any particular node of the network pathway, improving security of the communication channel.

In some examples, operations of the system discussed herein may occur within milliseconds, seconds, and/or minutes of each other such that the second communication channel is established with a reduced and/or minimal delay from the termination event affecting the first communication channel. For instance, signaling to set up the second communication channel may occur in less than two seconds and/or within 200 milliseconds. For instances, in some examples, the system discussed herein may establish the second communication channel absent additional user input, or with only minimal user input, to improve a speed and efficiency with which the second communication channel is established, and/or to reduce a disruption to the conference call caused by the termination event.

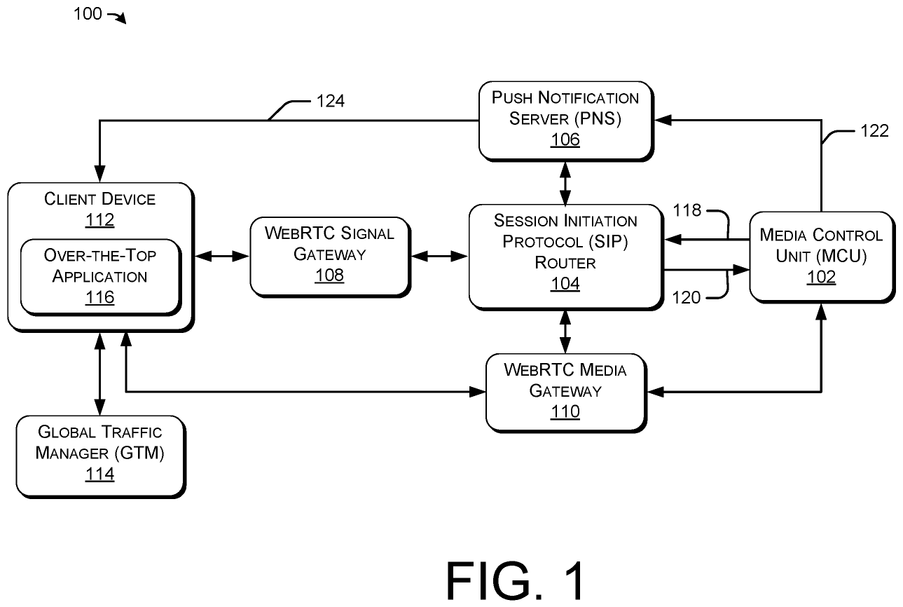

FIG. 1 depicts an example system 100 for establishing a SIP channel via a push message. In some examples, the system 100 may comprise at least a portion of a 3rd Generation Partnership Program (3GPP) network or a non-3GPP network, such as a 3G network, a 4G network, a 4G Long Term Evolution (LTE) network, a LTE Advanced network, a 5G network, an evolved IP Multimedia System (IMS) network, a Wi-Fi network, combinations thereof, and the like. The system 100 may comprise a portion of other types of networks. The system 100 may include one or more network nodes in communication with each other, such as an MCU 102, a SIP router 104, a PNS 106, a WebRTC signal gateway 108, a WebRTC media gateway 110, a client device 112, a Global Traffic Manager (GTM) or Global Server Load Balancer (GSLB) (herein referred to as the “GTM” for brevity) 114, and/or combinations thereof.

In some instances, the MCU 102 may facilitate a conference call for multiple client devices by providing a bridge communication connecting a plurality of client devices and normalizing communications between the plurality of devices during the conference call. The SIP router 104 may perform operations for setting up one or more communication channels of the conference call by transmitting SIP signaling between the WebRTC signal gateway 108 and the MCU 102 (e.g., to set up the conference call), and between the WebRTC media gateway 110 and the MCU 102 (e.g., to transmit data during the conference call). In some examples, the WebRTC signal gateway 108 may communicate with an OTT application 116 operating on the client device 112, and may connect the OTT application 116 to the SIP router 104. The WebRTC media gateway 110 may provide a Real-Time Communication (RTC) channel between the client device 112 (e.g., the OTT application 116) and the MCU 102, for instance, for transmitting media between the client device 112 and the MCU 102 during the conference call after the commination channel has been established. The WebRTC signal gateway 108 and the WebRTC media gateway 110 may translate HTTP traffic from the OTT application 116 to SIP traffic understood by the SIP router 104 and/or the MCU 102. The PNS 106 may transmit push messages back and forth to the client device 112 via the OTT application 116. The GTM 114 may detect traffic flow and/or latency of one or more channels, for instance, to detect a site-level outage. For instance, the GTM may detect a latency associated with a communication channel being greater than a predetermined latency threshold.

In some examples, upon establishing the conference call, the MCU 102 may determine an occurrence of a termination event indicating that a first communication channel associated with the client device 112 has entered an inactive status or lost connection status, or that communication between the MCU 102 and the client device 112 has otherwise faltered. For instance, the MCU 102 may communicate with and/or may comprise a state machine to track connection dialogs associated with the client device 112. The MCU 102 may send a BYE-check SIP message 118 to the WebRTC signal gateway 108 via the SIP router 104 requesting an indication of a presence or an absence of a BYE message stored at the WebRTC signal gateway 108, the BYE message being associated with a client device identifier corresponding to the client device 112 and/or the first communication channel. In some examples, the MCU 102 may receive a BYE-check response SIP message 120 from the WebRTC signal gateway 108 via the SIP router 104 indicating the absence of the BYE message at the WebRTC signal gateway 108. The MCU 102 may, based at least in part on receiving the BYE-check response SIP message 120, determine to send a call message 122 to the PNS 106 instructing the PNS 106 to send a push message 124 to the client device 112. The PNS 106 may, at least partly in response to receiving the call message 122, send the push message 124 to the client device 112. Upon receiving the push message 124, the client device 112 may establish a second channel with the MCU 102 (e.g., via the WebRTC signal gateway 108 and the SIP router 104). The components and operations depicted in FIG. 1 are discussed in greater detail below.

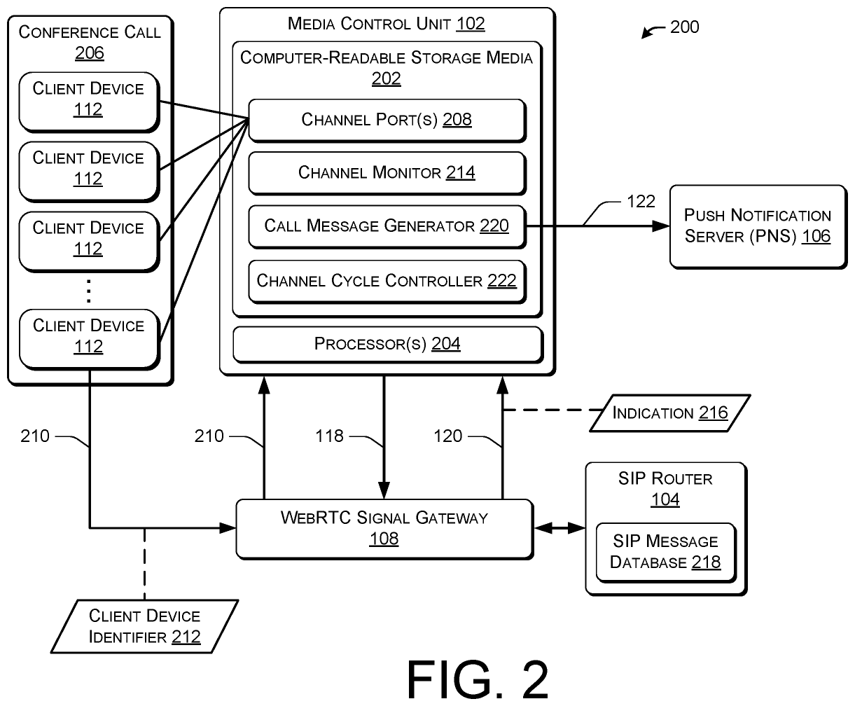

FIG. 2 depicts a schematic diagram of an example system 200 including at least the MCU 102. FIG. 2 depicts one or more components of the MCU 102, one or more operations performed by the MCU 102, and/or data transmissions between the MCU 102 and other network nodes, for instance, of the system 100. System 200 may be similar to, identical to, and/or may form a portion of any of the systems discussed herein.

In some instances, the MCU 102 may comprise one or more computer-readable storage media 202, such as non-transitory computer-readable media including, but not limited to, phase change memory (PCM), static random-access memory (SRAM), dynamic random-access memory (DRAM), other types of random access memory (RAM), read only memory (ROM), electrically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, a quantum-state storage device, genetic encoding storage device, combinations thereof, or any other medium that can be used to store information for access by an electronic computing device. Databases discussed herein, for instance stored at computer-readable storage media 202, may include one or more of a comma delimited list, a spreadsheet, an array, an SQL data structure, a GraphQL data structure, a NoSQL data structure, a hash-based data structure, an object-based data structure, or any other data type, data structure, and/or data system for storing retrievable data. For instance, a NoSQL server may track the state of SIP dialogs, such as active call legs of a conference call 206.

In some examples, the MCU 102 may comprise one or more processor(s) 204, such as a microprocessor, a microcomputer, a microcontroller, a digital signal processor, a central processing unit (CPU), a graphics processing unit (GPU), a quantum processor, combinations thereof, etc. Among other capabilities, the one or more processor(s) 204 may operate to fetch and execute computer-readable instructions stored in the one or more memory storage device(s) 202, for instance, to perform the operations disclosed herein.

In some examples, the MCU 102 may control the receipt, rendering, transmission, and/or storage of media (e.g., audio, video, data) during the conference call 206. For instance, the MCU 102 may establish the conference call 206 for a plurality of client devices 112, such that the plurality of client devices 112 can communicate with each other during the conference call 206. The MCU 102 may normalize audio codec and/or video codec received from and sent to and the plurality of client devices 112 such that the plurality of client devices 112 are provided a substantially uninterrupted flow of clear audio/video data during the conference call 206. The MCU 102 may include a vector graph and other binary or meta data, Rich Communication Services (RCS) and/or other messaging protocol(s).

In some examples, the MCU 102 may comprise one or more channel port(s) 208, which may include one or more audio ports, video ports, other type of data port, or combinations thereof. The channel port(s) 208 may comprise an interface of the MCU 102 designated for receiving communications from a particular client device (e.g., of the plurality of client devices 112) assigned to the particular port. For instance, the MCU 102 may receive a first SIP message 210 from the WebRTC signal gateway 108 via the SIP router 104. The first SIP message 210 may include a confirmation and/or a personal identification number (PIN), generated at the client device 112, and/or a device identifier 212 that corresponds to the client device 112. The first SIP message 210 may be sent from the client device 112 at least partly in response to an invite message received at the client device 112.

In some embodiments, the MCU 102 may assign the channel port 208 to the client device 112 based at least in part on receiving the first SIP message 210 such that a first communication channel is established between the client device 112 and the MCU 102. The MCU 102 may receive communications from the client device 112 and/or send communications to the client device 112 via the channel port 208 assigned to the client device 112.

In some examples, the MCU 102 may comprise a channel monitor 214, for instance, stored at the computer-readable storage media 202. The channel monitor 214 may detect a status of the conference call 206 and/or a status of the one or more channel port(s) 208 receiving data from the one or more client devices 112 during the conference call 206. For instance, via the channel monitor 214, the MCU 102 may determine an occurrence of a termination event associated with the channel port 208 and/or the client device 112. The MCU 102 may determine the occurrence of the termination event based on an absence of RTP on a media channel (e.g., via the WebRTC media gateway 110) without the BYE message. The MCU 102 may determine the occurrence of the termination event based, at least partly, on detecting that the MCU 102 has stopped receiving communications from the client device 112 at the channel port 208 assigned to the client device 112 and/or at a media port providing RTP associated with the client device 112. In some examples, the MCU 102 may determine the occurrence of the termination event based at least partly on an amount of communications or media (e.g., voice, text, video, data, etc.) received from the client device 112 comprising near zero for a predetermined amount of time threshold. In some instances, the MCU 102 may determine the occurrence of the termination event based at least partly on a number of active client devices 112 participating in the conference call 206 decrementing an integer value (e.g., going from four participating client devices 112 to three participating client devices). In some examples, the MCU 102 may determine the occurrence of the termination event based at least partly on receiving a message, for instance, from another network node of the system 100, indicating the occurrence of the termination event. For instance, the SIP router 104 may determine that no media is being received from the WebRTC signal gateway 108 associated with the client device 112 and may, at least partly in response, send a message to the MCU 102 indicating the occurrence of the termination event. The MCU 102 may determine that the termination event is associated with the client device 112, for instance, based on the client device identifier 212 associated with the channel port 208 effected by the termination event.

In some examples, the MCU 102 may query the WebRTC signal gateway 108 by sending the BYE-check SIP message 118 (e.g., a state machine query) to the WebRTC signal gateway 108. For instance, the BYE-check SIP message 118 may include the client device identifier 212 and a request for a response indicating whether a BYE message associated with the client device identifier 212 is stored at the WebRTC signal gateway 108 and/or at a SIP message database 218 of the SIP router 104 (e.g., a state machine for sessions and dialogs, which may comprises separate system or may be stored in a local data store). In some examples, based at least partly on receiving the BYE-check SIP message 118, the WebRTC signal gateway 108 may determine an absence or a presence of the BYE message associated with the client device identifier 212. For instance, the WebRTC signal gateway 108 may send the BYE-check response SIP message 120 to the MCU 102 based at least partly on receiving the BYE-check SIP message 118 at the WebRTC signal gateway 108 and/or determining the absence or the presence of the BYE message at the WebRTC signal gateway 108.

In some examples, the state machine may comprise a RAM-based database replicated across 4 sites. All SIP comms may go through the router. This may be where CDRs are cut and sessions/resources are tracked. Media can be direct between points, but signaling may follow a path of client→edge node or gateway→sip router→internal node (the MCU 102 in some instances).

In some embodiments, the MCU 102 may receive the BYE-check response message 120, for instance, from the WebRTC signal gateway 108. In some instances, the BYE-check response message 120 may include an indication 216 that that the BYE message associated with the client device identifier 212 is absent from and/or not present at the WebRTC signal gateway 108 and/or the SIP message database 218. The MCU 102 may determine to send the call message 122 to the PNS 106 based at least partly on receiving the indication 216.

In some examples, the MCU 102 may generate the call message 122, for instance, via a call message generator 220 stored in the computer-readable storage media 202. The call message generator 220 may generate the call message 122 based, at least in part, on receiving the indication 216. The call message generator 220 may generate the call message 122 according to one or more formatting rules corresponding to, for instance, a Representational State Transfer (REST) API associated with the PNS 106. The formatting rules may be stored and/or accessed by the call message generator 220. In some instances, the call message generator 220 may access and/or store one or more network addresses corresponding to the PNS 106, and the call message generator 220 may insert the network address corresponding to the PNS 106 in the call message 120, for instance, as a terminating node address for the call message 120. In some examples, the WebRTC signal gateway 108 or the SIP router 104 may trigger the push message 124, for instance, by generating the call message 120 and/or by sending the call message 120 to the PNS 106

In some examples, the BYE-check response message 120 may include an indication that the BYE message associated with the client device identifier 212 is stored at the WebRTC signal gateway 108 (e.g., is present and/or is not absent). In response, the MCU 102 may determine to not send the call message 122 to the PNS 106 and/or may determine to terminate one or more procedures or operations related to establishing a second communication channel for the client device 112 at the MCU 102 prior to completing establishing the second communication channel. In some instances, the WebRTC signal gateway 108, the SIP router 104, and/or the MCU 102 may send the call message 112 to the PNS 106.

In some instances, the MCU 102 may receive a second SIP message, for instance, from the WebRTC signal gateway 108 via the SIP router 104, to establish a second communication channel between the client device 112 and the MCU 102. In some instances, the second communication channel may be established based, at least in part on the MCU 102 detecting the occurrence of the termination event and/or sending the call message 122 to the PNS 106. In some examples, the second communication channel may be established based on one or more communications between the client device 112 and the PNS 106, as discussed in greater detail below.

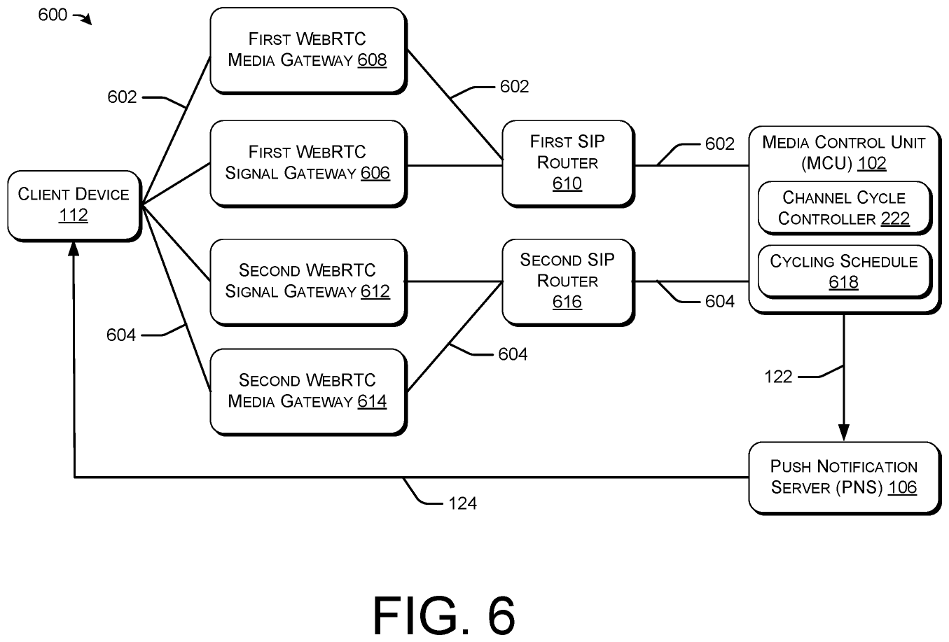

In some examples, the MCU 102 may comprise a channel cycle controller 222. The channel cycle controller 222 may comprise one or more software algorithms for controlling operations of the MCU 102 such that the MCU 102 may cycle the channel port 208 through a plurality of different network pathways, for instance, to enhance data transmission security. Operations of the channel cycle controller 222, such as sending multiple call messages that indicate different WebRTC signal gateways 108, are discussed in greater detail below with regards to FIG. 6.

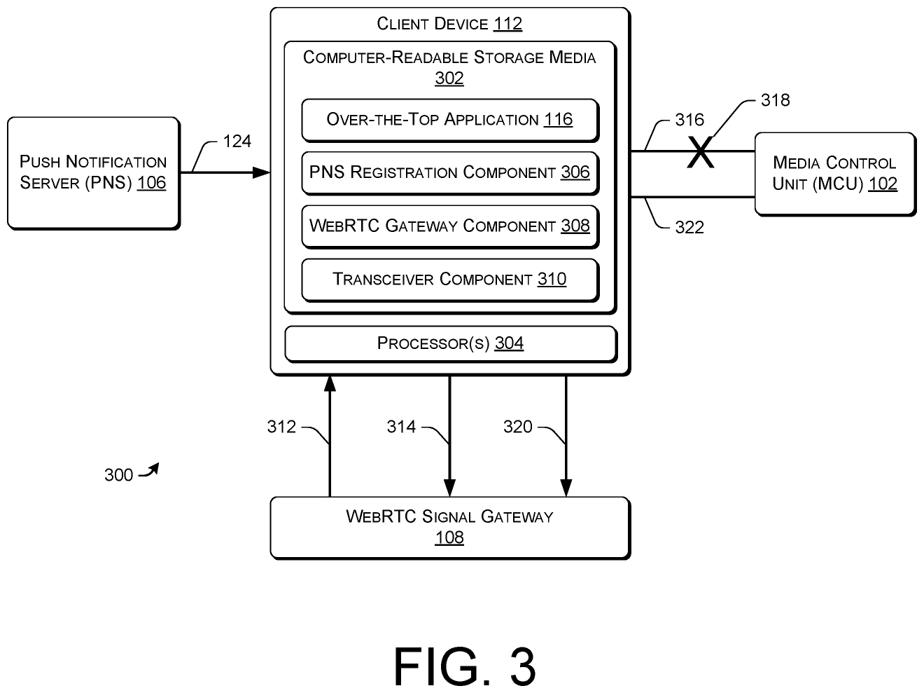

FIG. 3 depicts a schematic diagram of an example system 300 including at least the client device 112. FIG. 3 depicts one or more components of the client device 112, one or more operations performed by the client device 112, and/or one or more data transmissions between the client device 112 and other network nodes, for instance, of the system 100. System 300 may be similar to, identical to, and/or form a portion of any of the systems discussed herein.

In some examples, the client device 112 may comprise a local computing device, a consumer electronic device, and/or an enterprise electronic device. For instance, the client device 112 may comprise a mobile phone device (e.g., a smartphone), a laptop computer, a desktop computer, a wearable-computing device (e.g., glasses, watch, necklace, contact lens, epidermal, subdermal implant, etc.), a stand-alone computer (e.g., raspberry pi, an external drive, etc.), an electronic book (eBook) reader device, a gaming console, a tablet computing device, an augmented reality device, a virtual reality device, or combinations thereof.

In some examples, the client device 112 may comprise one or more computer-readable storage media 302, such as non-transitory computer-readable media including, but not limited to, phase change memory (PCM), static random-access memory (SRAM), dynamic random-access memory (DRAM), other types of random access memory (RAM), read only memory (ROM), electrically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, a quantum-state storage device, genetic encoding storage device, combinations thereof, or any other medium that can be used to store information for access by an electronic computing device. Databases discussed herein, for instance stored at computer-readable storage media 302, may include one or more of a comma delimited list, a spreadsheet, an array, an SQL data structure, a GraphQL data structure, a NoSQL data structure, a hash-based data structure, an object-based data structure, a Lucene database (e.g., Elastic Search), or any other data type, data structure, and/or data system for storing retrievable data.

In some embodiments, the client device 112 may comprise one or more processor(s) 304 such as a microprocessor, a microcomputer, a microcontroller, a digital signal processor, a central processing unit (CPU), a graphics processing unit (GPU), a quantum processor, a WAIT-STATE processor, other distributed processors, combinations thereof, etc. Among other capabilities, the one or more processor(s) 304 may operate to fetch and execute computer-readable instructions stored in the one or more memory storage media 302 to perform the operations disclosed herein.

In some examples, the client device 112 may comprise the OTT application 116, for instance, to communicate with the WebRTC signal gateway 108 and/or the WebRTC media gateway 110 via an application-layer protocol (e.g., SIP), or any application server (AS) or service gateway. The OTT application 116 may comprise one or more algorithms, stored at the computer-readable media 302, for transmitting data between the client device 112 and the WebRTC signal gateway 108, the WebRTC media gateway 110, the PNS 106, and/or the GTM 114. In some instances, the OTT application 116 may interact with other applications and/or software components of the client device 112. For instance, the OTT application 116 may interact with and/or include a PNS registration component 306, a WebRTC gateway component 308, and/or a transceiver component 310. For instance, the PNS registration component 306 may register with the PNS 106 via the WebRTC signal gateway 108. The transceiver component 310 may control one or more operations of wireless communication hardware of the client device 112, such as a Wi-Fi transceiver that establishes a Wi-Fi connection with a router that, in turn, establishes a TCP/IP connection with a server device, a cellular radio access network (RAN) modem for connecting with a RAN network, and/or other hardware/software components and/or communication protocols for sending information from the computer-readable storage media 302 of the client device 112 to another computer-readable storage media located remotely from the client device 112.

In some examples, based at least partly on one or more messages received at the client device 112, the OTT application 116 may cause the client device 112 to perform one or more functions, such as subscribing with the PNS 106 for push notifications/push messages from the PNS 106 (e.g., via the PNS registration component 306), sending a SIP REGISTER message to the WebRTC signal gateway 108 to establish the conference call 206 with the MCU 102 (e.g., via the WebRTC gateway component 308), and sending media to and/or receiving media from the WebRTC media gateway 110 to communicate with other client devices during the conference call 206. In some examples, the SIP router 104 may be located between the WebRTC signal gateway 108 and the MCU 102.

In some embodiments, the MCU 102 may not be exposed publicly. The client device 112 may send media and signaling through a gateway, such as the WebRTC Signal Gateway 108. A break in communication may happen between the client and WebRTC Signal gateway 108, the site of the WebRTC signal gateway 308 and all nodes could fail, and/or the MCU 102 or a cluster of MCU 102 devices could fail.

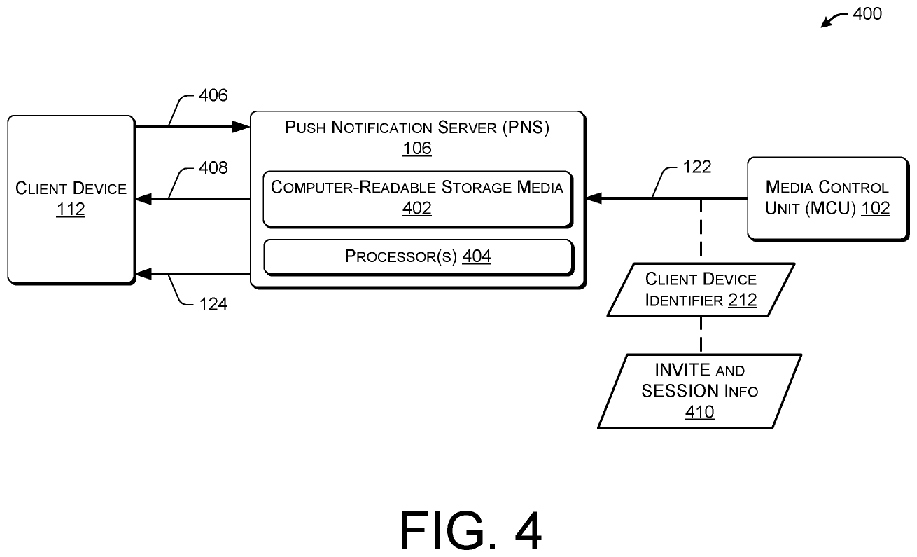

In some examples, the client device 112 may register with the PNS 106 to receive messages (e.g., push messages) from the PNS 106, for instance, at the PNS registration component 306 and/or the OTT application 116 (which may include the PNS registration component 306) of the client device 112. Operations of the PNS 106 are discussed in greater detail below, at least regarding FIG. 4.

In some embodiments, the client device 112 may receive a SIP INVITE message 312, for instance, from the WebRTC signal gateway 108. The SIP INVITE message 312 may include information corresponding to the conference call 206 and an invitation for the client device 112 to join the conference call. For instance, the SIP INVITE message 312 may include one or more PIN entry field prompts for receiving a PIN via a user input at the client device 112. The SIP INVITE message 312 may include routing information for establishing the communication channel between the client device 112 and the MCU 102 (e.g., by connecting the client device 112 to the channel port 208), upon receiving a confirmation user input at the client device 112. The SIP INVITE message 312 may cause the client device 112 to register with the SIP router 104. The MCU 102 may become aware of the client device 112 once the SIP INVITE message 312 is accepted at the client device 112. For instance, in response to receiving the SIP INVITE message 312, the client device 112 (e.g., via the WebRTC gateway component 308) may send a first SIP REGISTER message 314 to the WebRTC signal gateway 108, which may, in turn, send the first SIP REGISTER message 314 to the MCU 102 (e.g., via the SIP router 104). In some examples, the WebRTC signal gateway 108 and/or the SIP router 104 may be located between the client device 112 and the MCU 102.

In some examples, upon the client device 112 sending the first SIP REGISTER message 314 and registering with the SIP router 104, the MCU 102 may establish a first communication channel 316, such as an RTC channel, between the client device 112 and the MCU 102. For instance, the WebRTC media gateway 110 may act as an intermediary, communicating with the OTT application 116 to receive media sent from the client device 112 during the conference call 206 (e.g., voice data, video data, text data, etc.), and the WebRTC media gateway 110 may send, to the client device 112, other media received at the MCU 102 by other client devices participating in the conference call 206.

In some examples, a termination event 318 may occur at the client device 112, such as the termination events discussed above. For instance, the termination event 318 may comprise the client device 112 having a signal strength weakened or lost during the conference call 206 such that the client device 112 is unable to communicate with the WebRTC media gateway 110, and/or other network nodes. For instance, the client device 112 may move out of range of a cell tower providing RAN coverage (e.g., while in a driving vehicle). The termination event 318 may comprise the WebRTC media gateway 110 not receiving a message associated with the client device 112 for a predetermined threshold amount of time (e.g., 30 second, 1 minute, 2 minutes, etc.). The termination event 318 may comprise a network node (e.g., the WebRTC media Gateway 110, the SIP router 104, etc.) experiencing a power outage or other function failure. The termination event 318 may comprise the client device 112 experiencing a power outage or other function failure. The termination event 318 may comprise a shutdown of an application (e.g., the OTT application 116) operating at the client device 112. The termination event 318 may comprise another event causing the client device 112 to stop communicating with the MCU 102 absent an intentional disconnect at the client device 112. The termination event 318 may comprise other network-based failures or errors, such as a node failure. The intentional disconnect, the absence of which may indicate the occurrence of the termination event 318, may comprise a user input actuating a graphical user interface element of a graphical user interface displayed at the client device 112 to intentionally remove the client device 112 from the conference call 206. In some examples, the client device 112 may send a BYE message based in part on the user input indicating the intentional disconnect (e.g., upon actuating an “end call” graphical user interface element of the OTT application 116, or by powering-off the client device 112). An indication that the BYE message was received may be stored or otherwise received at the SIP router 104, a state machine, and/or at other network nodes as discussed in greater detail below. The BYE message and/or an indication that the BYE message was received may represent a lack of the termination event 318 associated with the client device 112 leaving the conference call 206.

In some examples, the client device 112 may receive the push message 124, for instance, from the PNS 106. The push message 124 may include a notification that the client device 112 is disconnected from the conference call 206 and/or a prompt for reconnecting the client device 112 to the MCU 102 to rejoin the conference call 206. The prompt may be displayed at the graphical user interface of the client device 112. In some examples, the push message 124 may include executable-instructions that are automatically executed at the client device 112 (e.g., absent a user input), such that the client device 112 reconnects to the MCU 102 and the conference call 206 upon receiving the push message 124 with minimal delay (e.g., within less than ten seconds, less than 30 seconds, less than one minutes, etc.).

In some examples, the client device 112, for instance, via the OTT application 116, may, based at least in part on the push message 124, determine to send a second SIP REGISTER message 320 to the WebRTC signal gateway 108. For instance, the SIP REGISTER message 320 may be sent to establish a second communication channel 322 (e.g., a second RTC channel via the WebRTC media gateway 110).

In some embodiments, upon sending the SIP REGISTER message 320, the client device 112 may reestablish media and join the conference call 206. For instance, upon receiving the SIP REGISTER message 320 and/or determining to reestablish media, the SIP router 104 may send an INVITE, REINVITE, and/or REFER SIP message to the MCU 102, and in response, the MCU 102 may assign a second channel port (which may be a same channel port as the channel port 208 or a different channel port) to the client device 112. The WebRTC media gateway 110 may transmit data between the client device 112 and the MCU 102 via the second communication channel 322 such that the client device 112 may participate in the conference call 206. In some instances, the client device 112 may rejoin the conference call 206 via the second communication channel 322 after unintentionally losing communication via the first communication channel 316. In some example, re-establishing the client device 112 participation in the conference call 206 via the systems discussed herein may provide a fault tolerance system for rejoining the conference call 206 on the order of seconds or minutes after the occurrence of the termination event 318.

FIG. 4 depicts a schematic diagram of an example system 400 including at least the PNS 106. FIG. 4 depicts one or more components of the PNS 106, one or more operations performed by the PNS 106, and/or one or more data transmissions between the PNS 106 and other network nodes, for instance, of the system 100. System 400 may be similar to, identical to, and/or form a portion of any of the systems discussed herein.

In some examples, the PNS 106 may comprise one or more computer-readable storage media 402 that may be similar and/or identical to the computer-readable storage media 202 of the MCU 102 and/or the computer readable storage media 302 of the client device 112.

In some embodiments, the PNS 106 may comprise one or more processor(s) 404 such as a microprocessor, a microcomputer, a microcontroller, a digital signal processor, a central processing unit (CPU), a graphics processing unit (GPU), a quantum processor, combinations thereof, etc. Among other capabilities, the one or more processor(s) 404 may operate to fetch and execute computer-readable instructions stored in the one or more memory storage media 402 to perform the operations disclosed herein.

In some examples, the PNS 106 may send one or more push messages to the one or more client device(s) 112. The one or more push messages may comprise an unsolicited or polled-for transmission from the PNS 106 to the one or more client device(s) 112. The one or more push messages may be transmitted via OTT services, e.g., using REST-based protocols and/or other API protocols (e.g. Simple Object Access Protocol (SOAP), Java Message Service (JMS), etc.). The PNS 106 may establish one or more push notification sessions with the client device(s) 112 (e.g., via one or more applications running on the client device(s) 112). For instance, the OTT application 116 operating on the client device 112 may register with the PNS 106.

In some examples, the PNS 106 may receive a request for push notification service from the client device 112, for instance, via a Push SUBSCRIBE message 406 sent from the client device 112 and/or sent from the WebRTC signal gateway 108. The Push SUBSCRIBE message 406 may include information associated with the client device 112 (e.g., the client device identifier 212) and an indication that the client device 112 is configured to and/or expecting to receive push messages from the PNS 106. Upon receiving the Push SUBSCRIBE message 406, the PNS 106 may send, to the client device 112, a Push CONFIRM message 408, that may include push/pull session information such as, a push/pull session ID and/or an application ID. In response, the client device 112 may send a Push ACKNOWLEDGE message. Accordingly, the PNS 106 may register the client device 112 with the PNS 106 to receive push messages from the PNS 106.

In some embodiments, the PNS 106 may receive the call message 122, for instance, from the MCU 102 and/or from the SIP router 104. The call message 122 may include the client device identifier 212, INVITE and SESSION information 410, and/or an instruction to send the push message 124 to the client device 112 associated with the client device identifier 212. The INVITE and SESSION information 410 may comprise information similar to and/or identical to information comprising the first SIP REGISTER message 314 for establishing the first communication channel 316. For instance, the INVITE and SESSION information 410 may contain the PIN and/or the confirmation and/or other information, that may be readable by the WebRTC signal gateway 108 and/or the SIP router 104, for establishing the second communication channel 322. In some instances, the WebRTC signal gateway 108 may receive one or more REST API calls, and may translate the one or more REST API calls into the SIP messages, and vice versa. Push notifications may be initiated by the MCU 102 and/or they may be controlled by the WebRTC signal gateway 108. In other words, the push notification may be sent in response to a direct communication or through a proxy or controller device.

In some examples, the PNS 106 may send the push message 124 to the client device 112, for instance, based at least in partly on receiving the call message 122 at the PNS 106. The push message 124 may include the notification that the client device 112 is disconnected and/or a prompt for reconnecting the client device 112 to the MCU 102 to rejoin the conference call 206 (e.g., that may be displayed at the graphical user interface of the client device 112). The push message may include the INVITE and SESSION information 410 and/or information based on the INVITE and SESSION information 410 for establishing the second communication channel 322. In some examples, the push message 124 may include instructions that are executable upon being received at the client device 112 (e.g., absent the user input) for establishing the second communication channel 322. In other words, the push message 124 may cause the client device 112 to establish the second communication channel 322 automatically without the prompt or receiving a response to the prompt.

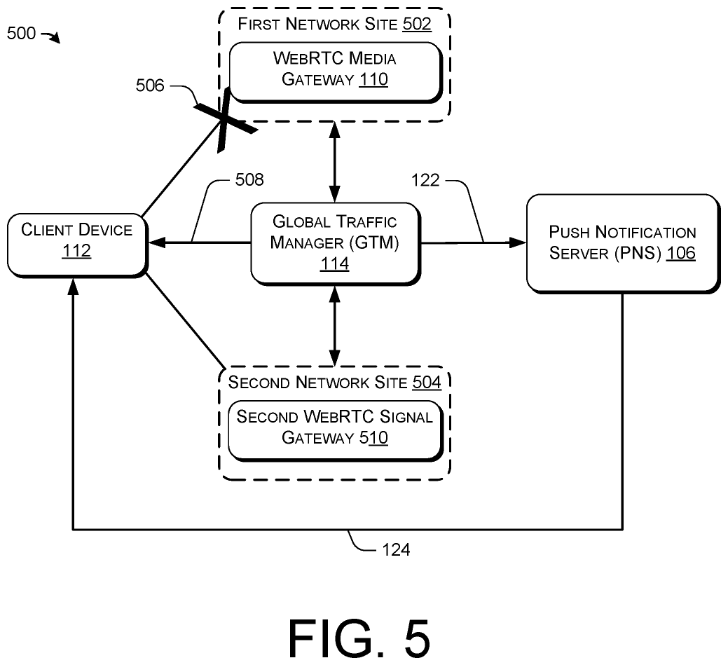

FIG. 5 depicts a schematic diagram of an example system 500, which may be similar to, identical to, and/or form a portion of the systems disclosed herein. The example system 500 depicted in FIG. 5 includes a first network site 502, a second network site 504, and operations for rerouting one or more client devices 112 from the first network site 502 to the second network site 504 based, at least in part, on detecting a site outage 506 associated with the first network site 502.

In some examples, the system 500 may include the GTM 114. The GTM 114 may comprise a network node for monitoring and/or managing network health (e.g., traffic activity) for one or more network sites. For instance, the GTM 114 may communicate with the WebRTC media gateway 110 to detect whether data is flowing to and/or from the WebRTC media gateway 110. In some examples, the WebRTC media gateway 110 may form a part of the first network site 502. The first network site 502 may comprise network nodes serving a first region, such as a U.S. metropolitan region (e.g., New York City, Denver, etc.).

In some embodiments, the GTM 114 may detect or otherwise determine an occurrence of the site outage 506 occurring at the first network site 502. The GTM 114 may detect that media traffic flowing to and/or from the WebRTC media gateway 110 operating at the first network site 502 has substantially stopped, and/or may detect other latency problems affecting the first network site 502. For instance, the GTM 114 may determine the occurrence of the site outage 506 based on media traffic stopping or slowing for multiple communication channels in session during/prior to the site outage 506 (e.g., during the conference call 206). In some instances, the GTM 114 may determine the occurrence of the site outage 506 based on the multiple communication channels being lost or slowed within a predetermined threshold of time of each other, such as within 30 seconds, one minute, five minutes, etc. The GTM 114 may determine, for instance, by aggregating location data and/or timestamps associated with a plurality of termination events comprising the site outage 506, a region (e.g., city, state, or other geographic area) affected by the site outage 506, and may send a plurality of call messages 122, push messages 124, and/or one or more Domain Name System (DNS) message(s) 508 to client devices 112 associated with the region.

For instance, upon determining the occurrence of the site outage 506, the GTM 114 may determine to send the call message 122 to the PNS 106. In some examples, the GTM 114 may determine to send, to the PNS 106, multiple call messages corresponding to multiple client devices 112 associated with multiple communication channels of the first network site 502 that experienced the site outage 506. For instance, one or more call messages 122 may each include a client device identifier 212 corresponding to a client device 112 that the GTM 114 determines experienced the site outage 506. In some examples, the GTM 114 may send a message to the MCU 102 indicating the occurrence of the site outage, such that the MCU 102 may determine to send the one or more call messages 122.

In some embodiments, the PNS 106 may send the push message 124, for instance, in response to receiving the call message 122 from a second WebRTC signal gateway 510, which may be aware of the site outage via a state machine replicating data between one or more network sites (e.g., first network site 502, second network site 504, etc.). The push message 124 may include the client device identifier 212, the INVITE and SESSION information 410 associated with the second WebRTC signal gateway 510 of the second network site 504, and/or an instruction to initiate a communication channel with a second MCU of the second network site 504 (e.g., by sending a second SIP REGISTER message to the second WebRTC signal gateway 510). In some instances, the PNS 106 may send multiple push messages 124 corresponding to the multiple client devices 112 affected by the site outage 506. In response, the second WebRTC signal gateway 510 may establish multiple second communication channels for the multiple client devices 112 so that the multiple client devices 112 may participate in a second conference call at the second network site 504 and/or a continuation of the conference call 206. Accordingly, in some instances, the GTM 114 may shift network pathways of one or more client devices 112 from the first network site 502 to the second network site 504, via one or more push messages 124 from the PNS 106, upon determining the occurrence of the site outage 506

In some embodiments, additionally or alternatively to sending the call message 122 to the PNS 106, the GTM 114 may send the DNS message 508 to the client device 112 and/or multiple DNS messages 508 to the multiple client devices 112 affected by the site outage 506. The DNS message(s) 508 may include a script directing the OTT application 116 to a specified domain, for instance via a web portal operating at the client device 112. The specified domain may include executable instructions that may perform similar or identical operations as the push message 124. For instance, based at least partly on visiting the specified domain, the client device 112 (e.g., via the OTT application 116) may determine to send the second SIP REGISTER message to the second WebRTC signal gateway 510 of the second network site 506.

FIG. 6 depicts a schematic diagram of an example system 600, which may be similar to, identical to, and/or form a portion of the systems disclosed herein. The example system 600 depicted in FIG. 6 may include at least the MCU 102, the channel cycle controller 222, a first network pathway 602, and/or a second network pathway 604 In some instances, FIG. 6 depicts operations of the system 600 for cycling network pathways of the client device 112 (e.g., from the first network pathway 602 to the second network pathway 604), which in some examples may enhance security of data sent between the client device 112 and the MCU 102, for instance, during the conference call 206.

In some examples, the system 600 may include the first network pathway 602, which may comprise a particular arrangement of network nodes and operations of the network nodes for exchanging messages to provide a communication channel (e.g., the first communication channel 316) for the client device 112 and/or the MCU 102. A network pathway, in some instances, may be changed (e.g., by changing a particular network node performing operations of the system 100, and/or a particular message sent between network nodes). In some examples, a network pathway may be changed while maintaining the first communication channel 316 (e.g., a communicative coupling of the client device 112 to a particular channel port 208). A network pathway may be changed to establish the second communication channel 322. The first network pathway 602 may be established by a first WebRTC signal gateway 606 and may include a first WebRTC media gateway 608 and/or a first SIP router 610. The second network pathway 604, which may be established by a second WebRTC signal gateway 612 that is different than the first WebRTC signal gateway 606, may comprise at least one or more different network nodes than the first network pathway 602, such as a second WebRTC media gateway 614 and/or a second SIP router 616

In some embodiments, the MCU 102 may determine to cycle the first network pathway 602 (e.g., change one or more network nodes of the first network pathway 602 such that data transmitted from the client device 112 to the MCU 102 takes a different route, for instance, via the second network pathway 604). For instance, the MCU 102 may store a user preference, such as a security preference associated with the client device 112 (e.g., at the channel cycle controller 222). The security preference may include a cycling schedule 618 and/or an indication to activate a “secure mode.” For instance, the indication to activate the “secure mode” may be based on a user input received at the client device 112. Upon determining to enter the “secure mode,” the channel cycle controller 222 may determine to modify the first network pathway 602 such that the client device 112 is connected to the MCU 102 via the second network pathway 604, for instance, via the second WebRTC media gateway 614 and/or the second SIP router 616.

In some examples, the system 600 may store (e.g., at the MCU 102) one or more user preference(s) associated with the client device 112 and/or the client device identifier 212. For instance, the user preference(s) may comprise data stored at the computer-readable media 202 that may be associated with a user profile associated with the client device 112. The user preference(s) may be received, in some instances, via a user input during a setup procedure of the client device 112 (e.g., during a conference call 206 setup procedure. The user preference(s) may include one or more indications related to how the client device 112 interacts with other network nodes, for instance, under particular conditions. For instance, the user preference(s) may indicate that, in response to receiving the push message 124 and/or in response to determining the occurrence of the termination event 318, the client device 112 is to rejoin the conference call 206 (e.g., by sending the second SIP REGISTER message 320) without receiving a user input, or in other words, automatically. In some instances, the user preference(s) may indicate that the client device 112 is to receive the user input prior to sending the SIP REGISTER message 320. In some examples, the user preference(s) may indicate an audio and/or video input and/or output setting, for instance, corresponding to a hardware or software specification of the client device 112. In some examples, the user preference(s) may indicate information to be displayed at other client devices 112, for instance, during the conference call 206 (e.g., a name associated with the client device 112, a current location associated with the client device 112, etc.). In some instances, the call message 122, the push message 124, and/or the second SIP REGISTER message 320 may include the one or more user preference(s).

In some examples, upon determining to cycle the first network pathway 602, the MCU 102 may determine to change the network pathway of the client device 112 multiple times, at regular intervals, at irregular intervals, and/or at scheduled intervals according to the cycling schedule 618, for instance, to establish a third network pathway, a fourth network pathway, a fifth network pathway, and so forth. The cycling schedule 618 may include instructions, stored at the MCU 102, for changing a particular network node of a currently active network pathway of the client device 112 after a predetermined amount of time (e.g., a timing threshold) has elapsed. For instance, the cycling schedule 618 may indicate that the MCU 102 is to send a different call message 122 to the PNS 106 (e.g., that may instruct the PNS 106 to send a different push message 124, wherein the different push messages 124 instruct the client device 112 to communicate with a different WebRTC gateway than a currently active WebRTC gateway) about every one minute, about every two minutes, about every three minutes, about every four minutes, about every five minutes, about every ten minutes, about every 30 minutes, about every hour, about every two hours, about every three hours, about every four hours, etc.

In some embodiments, the MCU 102, the second WebRTC signal gateway 612, or the second SIP router 616 may determine to send the call message 122 to the PNS 106, instructing the PNS 106 to send the push message 124 to the client device 112. In some instances, the second WebRTC signal gateway 612 or the second SIP router 616 may send the push message 124 to the client device 112. The push message 124 may contain the client device identifier 212 associated with the client device 112, an identifier associated with the second WebRTC signal gateway 612, and/or an instruction to establish the second network pathway 604 via the second WebRTC signal gateway 612 such that communications sent between the client device 112 and the MCU 102 are transmitted by the second WebRTC media gateway 614. Upon receiving the push message 124, the client device 112 may send a SIP REGISTER message to the second WebRTC signal gateway 612 to establish the second network pathway 604. This process may be repeated multiple times to establish multiple different network pathways, for instance, according to the cycling schedule 618.

Accordingly, in some instances, security of communications of the client device 112 may be enhanced by changing network pathways. For instance, should a malicious actor (e.g., a “hacker”) acquire a network address of a particular network node of the first network pathway hoping to intercept data sent to or from the client device 112, that network address may become obsolete upon the MCU 102 changing the network pathway of the client device 112 from the first network pathway 602 to the second network pathway 604.

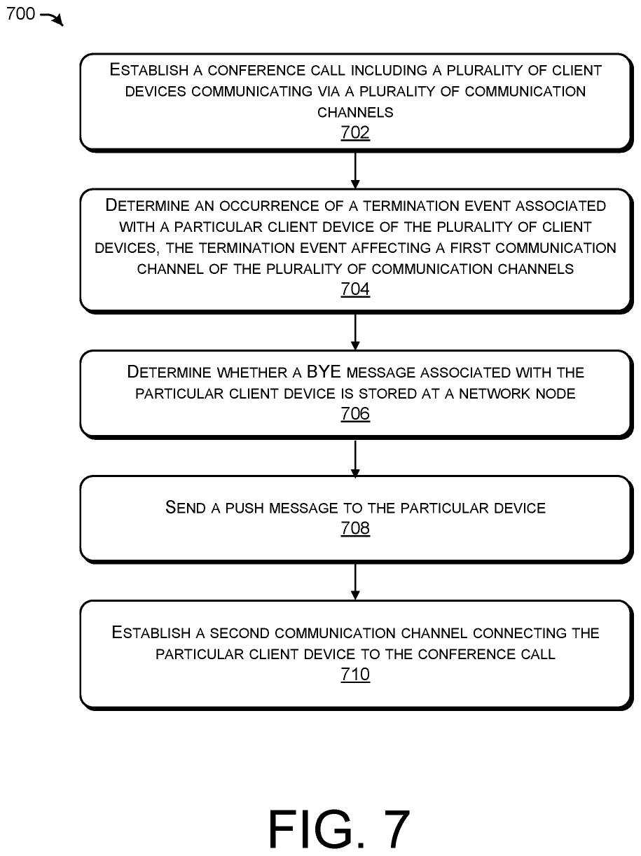

FIG. 7 depicts an example process 700 that may be performed by any of the systems discussed herein. The process 700 may include techniques for establishing a communication channel for the client device 112 via the push message 124.

At step 702, the process 700 may include establishing a conference call comprising a plurality client devices communicating via a plurality of communication channels. Each client device of the plurality of client devices may be assigned a particular communication channel of the plurality of communication channels. For instance, the MCU 102 may provide bridge communication between the plurality of client devices 112 to facilitate the conference call 206. The MCU 102 may normalize communications between the plurality of devices 112 during the conference call 206. The SIP router 104 may perform operations for setting up one or more communication channels of the conference call 206 by transmitting SIP messages between the WebRTC signal gateway 108 and the MCU 102 to set up the conference call 206, and/or between the WebRTC media gateway 110 and the MCU 102 to transmit data during the conference call 206. In some instances, the MCU 102 may comprise a plurality of channel ports 208 for receiving communications from the plurality of client devices 112. For instance, a communication channel (e.g., a RTC maintained by the WebRTC media gateway 110) may connect each channel port of the plurality of channel ports 208 to a client device of the plurality of client devices 112, such that media may be exchanged between the plurality of client devices 112, in real-time, during the conference call 206.

At step 704, the process 700 may include determining an occurrence of a termination event associated with a particular client device of the plurality of client devices, the termination event affecting a first communication channel of the one or more communication channels. For instance, the MCU 102 (e.g., via the channel monitor 214) may determine an occurrence of the termination event 318 associated with a particular client device of the plurality of client devices 112. The channel monitor 214, for instance, stored at the computer-readable storage media 202 of the MCU 102, may monitor a status of the conference call 206 and/or a status of the one or more channel port(s) 208 receiving data from the one or more client devices 112 during the conference call 206. Accordingly, the channel monitor 214 may provide continuous updates on a status of the plurality of communication channels. The channel monitor 214 may detect that the MCU 102 (and/or other network node(s), such as the WebRTC media gateway 110, the SIP router 104, the GTM 114, etc.) has stopped receiving communications from the client device 112, for instance, at the channel port 208 assigned to the client device 112.

In some examples, the MCU 102 may determine the occurrence of the termination event 318 based at least partly on an amount of communications or media (e.g., voice, text, video, data, etc.) received from the client device 112 comprising near zero, for instance, for a predetermined time period. In some instances, the MCU 102 may determine the occurrence of the termination event 318 based at least partly on a number of active client devices 112 participating in the conference call 206 decrementing an integer value. In some examples, the MCU 102 may determine the occurrence of the termination event 318 based at least partly on receiving a message, for instance, from another network node of the system 100, indicating the occurrence of the termination event 318. For instance, the SIP router 104 may determine that no media is being received from the WebRTC media gateway 110 associated with the client device 112 and may, at least partly in response, send a message to the MCU 102 indicating the occurrence of the termination event 318. The MCU 102 may determine that the termination event 318 is associated with the client device 112, for instance, based on the client device identifier 212 associated with the channel port 208 matching the client device identifier 212 associated with the termination event 318.

In some examples, determining the occurrence of the termination event 318 may include determining the occurrence of a site outage. For instance, the termination event 318 may comprise a plurality of termination events 318 affecting more than one of the plurality of communication channels, or even every communication channel of the plurality of communication channels. For instance, the GTM 114 may detect the site outage 506 occurring at the first network site 502. The GTM 114 may detect that media traffic flowing to and/or from the WebRTC media gateway 110 operating at the first network site 502 has substantially stopped, and/or may detect other latency problems affecting the WebRTC media gateway 110 and/or the first network site 502.

For instance, the GTM 114 may determine the occurrence of the site outage 506 based on media traffic stopping or slowing for multiple communication channels of the plurality of communication channels during the conference call 206. In some instances, the GTM 114 may determine the occurrence of the site outage 506 based on the multiple communication channels being lost or slowed within a predetermined threshold of time of each other, such as within 30 seconds, one minute, five minutes, etc. The GTM 114 may determine, for instance, by aggregating location data and/or timestamps associated with the plurality of termination events comprising the site outage 506, a region (e.g., city, state, or other geographic area) affected by the site outage 506.

At step 706, the process 700 may include determining whether a BYE message associated with the client device is stored at a network node. For instance, The MCU 102 may send the BYE-check SIP message 118 to the WebRTC signal gateway 108 requesting an indication of a presence or an absence of the BYE message stored at the WebRTC signal gateway 108, the BYE message being associated with the device identifier 212 corresponding to the client device 112 and/or the first communication channel 316. For instance, the BYE message may be stored at the WebRTC signal gateway 108 because the client device 112 may send the BYE message based in part on the user input indicating the intentional disconnect (e.g., upon actuating an “end call” graphical user interface element of the OTT application 116, or by powering-off the client device 112). In some instances, the BYE message may be stored as a Call Detail Report (CDR) or a Transaction Level Report (TLR). The BYE message may be stored at the SIP router 104, and/or at other network nodes. The presence of a stored BYE message may represent a lack of the termination event 318 associated with the client device 112 leaving the conference call 206. An absence of the BYE message may indicate an absence of the intentional disconnect.

At step 708, the process 700 may include sending a push message to the particular client device. For instance, the MCU 102 may determine to send the call message 122 to the PNS 106 instructing the PNS 106 to send the push message 124 to the client device 112 based at least partly on the absence of the BYE message. The PNS 106 may, at least partly in response to receiving the call message 122, send the push message 124 to the client device 112. The push message 124 may include a notification that the client device 112 has been disconnected and/or a prompt for reconnecting the client device 112 to the MCU 102 to rejoin the conference call 206 (e.g., displayed at the graphical user interface of the client device 112). In some examples, the push message 124 may include executable-instructions that are automatically executed at the client device 112 (e.g., absent a user input), such that the client device 112 reconnects to the conference call 206 provided by the MCU 102 upon receiving the push message 124.

In some examples, sending the push message 124 to the device associated with the first communication channel 316 and/or the termination event 318 may be based at least partly on detecting the site outage 506. The PNS 106 may send the push message 124 in response to receiving the call message 122 from the GTM 114. The push message 124 may include the client device identifier 212, INVITE and SESSION information 410 associated with the second WebRTC signal gateway 510 of the second network site 504, and/or an instruction to initiate the communication channel 322 with a second MCU of the second network site 504 (e.g., by sending the second SIP REGISTER message 320 to the second WebRTC signal gateway 510). In some instances, the GTM 114 may instruct the PNS 106 to send multiple push messages 124 corresponding to the multiple client devices 112 affected by the site outage 506. In response, the second WebRTC signal gateway 510 may establish multiple second communication channels 322 for the multiple client devices 112 so that they may participate in a second conference call at the second network site 504 (or a continuation of the first conference call 206. Accordingly, in some instances, the GTM 114 may shift network pathways of the multiple client devices from the first network site 502 to the second network site 504, via one or more push messages from the PNS 106, for instance, to resolve interruptions to the conference call 206 caused by the site outage 506.

In some examples, sending the push message 124 to the client device 112 associated with the first communication channel 316 and/or the termination event 318 may be at least partly based at least on the cycling schedule 618. For instance, upon determining to enter a “secure mode,” the MCU 102 may determine to send the call message 122 to the PNS 106, instructing the PNS 106 to send the push message 124 to the client device 112. The push message 124 may contain the client device identifier 212 associated with the client device 112, an identifier associated with the second WebRTC signal gateway 612, and/or an instruction to establish the second network pathway 604 via the second WebRTC signal gateway 612.

At step 710, the process 700 may include establishing a second communication channel connecting the particular client device to the conference call. For instance, the client device 112, (e.g., via the OTT application 116) may, based at least in part on receiving the push message 124, determine to send the second SIP REGISTER message 320 to the WebRTC signal gateway 108. Upon sending the second SIP REGISTER message 320, the client device 112 may rejoin the conference call 206. For instance, the SIP router 104 may route the second SIP REGISTER message 320 and/or information based on the second SIP REGISTER message 320 to the MCU 102, and in response, the MCU 102 may assign a second channel port (which may be a same channel port as the channel port 208 or a different channel port) to the client device 112. The WebRTC media gateway 110 may transmit data between the client device 112 and the MCU 102 via the second communication channel 322 such that the client device 112 may participate in the conference call 206. In some instances, the client device 112 may rejoin the conference call 206 via the second communication channel 322 after unintentionally losing communication via the first communication channel 316. In some example, re-establishing the client device 112 participation in the conference call 206 via the systems discussed herein may provide a fault tolerance system for correcting the conference call 206 on the order of seconds or minutes after the occurrence of the termination event 318.

In some embodiments (e.g., involving the site outage 506), the second communication channel 322 may be routed through a different network site (e.g., region) than the first communication channel 316. For instance, in response to receiving the push message 124, the client device 112 (and/or multiple client devices 112) may establish the second communication channel 322 (and/or multiple second communication channels 322) via the second WebRTC signal gateway 510 (that may be different than the WebRTC signal gateway 108), so that the client device(s) 112 may participate in a second conference call and/or a continuation of the interrupted first conference call (e.g., conference call 206) via the second network site 504.

In some examples (e.g., involving the channel cycle controller 222) upon receiving the push message 124, the client device 112 may send the second SIP REGISTER message 320 to the second WebRTC signal gateway 612 to establish the second network pathway 604. In some examples, the second network pathway 604 may include the second WebRTC media gateway 614 (which may comprise a different network node than the first WebRTC media gateway 608) and/or a second SIP router 616 (which may comprise a different network node than the first SIP router 610).

Although FIG. 7 depicts example operations, the described operations in these figures (and all other methods and operations disclosed herein) may be performed in other orders different than those illustrated in FIG. 7 and multiple steps may be performed simultaneously and/or in parallel. Furthermore, in some embodiments, one or more operations illustrated in FIG. 7 may be omitted, repeated, and/or combined with other operations illustrated in FIG. 7 and/or any other operations and components discussed in this disclosure. In some instances, any of the steps 702-710 may be performed at least partly in response to any other of the steps 702-710. In some instances, the operations discussed herein may be performed in multiple iterations for instance, to manage thousands, or even millions of client devices, conference calls, termination events, and/or site outages occurring on a global scale.

### Conclusion

Although this disclosure uses language specific to structural features and/or methodological acts, it is to be understood that the scope of the disclosure is not necessarily limited to the specific features or acts described. Rather, the specific features and acts are disclosed as illustrative forms of implementation.

What is claimed is:

1. A computing device comprising:
one or more processors; and
one or more computer-readable media storing computer-executable instructions that, when executed, cause the one or more processors to perform operations comprising:
establishing, via a WebRTC gateway and a Session Initiation Protocol (SIP) router, a conference call associated with a plurality of client devices;
determining an occurrence of a termination event associated with a client device of the plurality of client devices;
sending to the SIP router a first request for confirmation of an absence of a SIP BYE message indicator associated with the client device stored at a network node;
receiving the confirmation of the absence of the SIP BYE message indicator; and
sending, to a Push Notification Server (PNS) and based at least in part on receiving the confirmation, a first instruction to send a push message to the client device, the push message including a second instruction to rejoin the conference call.

2. The computing device of claim 1, wherein the termination event comprises a latency above a threshold or loss of connectivity associated with a communication channel connecting the client device to a channel port of the computing device.

3. The computing device of claim 1, wherein the second instruction to rejoin the conference call includes a third instruction to send a SIP REGISTER message to the WebRTC gateway and/or the SIP router.

4. The computing device of claim 1, wherein the WebRTC gateway comprises a first WebRTC gateway, the SIP router comprises a first SIP router, and the instruction to rejoin the conference call includes a third instruction to send a SIP REGISTER message to:
a second WebRTC gateway that is different than the first WebRTC gateway; or
a second SIP router that is different than the first SIP router.

5. The computing device of claim 1, wherein the instruction to rejoin the conference call comprises computer-readable instructions for establishing a communication channel for the client device via an absence of user input.

6. The computing device of claim 5, wherein initiating the communication channel for the client device via the absence of user input is based, at least in part, on a user preference associated with the client device and stored in the one or more computer-readable media indicating that the computing device is to automatically add the client device to the conference call based at least in part on:
the computing device determining the occurrence of the termination event; and
the computing device receiving the confirmation of the absence of the SIP BYE message indicator.

7. The computing device of claim 5, wherein determining the occurrence of the termination event comprises receiving an indication of an occurrence of a site outage, and the operations further comprise instructing the PNS to send multiple push messages to multiple client devices based, at least partly, on determining the occurrence of the site outage.

8. A computing device comprising:
one or more processors; and
one or more computer-readable media storing computer-executable instructions that, when executed, cause the one or more processors to perform operations comprising:
sending, via a WebRTC gateway and to a Media Control Unit (MCU), a first message to establish a first communication channel with the MCU;
receiving, from a Push Notification Server (PNS), a second message including:
an indication of a latency above a threshold or a loss of connectivity associated with the first communication channel; and
an instruction to establish a second communication channel with the MCU; and
sending, to the MCU and at least partly in response to receiving the instruction, a third message to establish the second communication channel.

9. The computing device of claim 8, wherein the sending the third message further comprises sending the third message to the WebRTC gateway.

10. The computing device of claim 8, further comprising an Over-the-Top (OTT) application, stored at the one or more computer-readable media, for establishing communication with the WebRTC gateway.

11. The computing device of claim 10, wherein the operations further comprise determining to send the third message via an absence of a user input at the client device.

12. The computing device of claim 8, wherein the operations further comprise, prior to sending the first message, receiving a Session Initiation Protocol (SIP) invite message from the MCU to establish the first communication channel.

13. The computing device of claim 8, wherein the first message comprises a Session Initiation Protocol (SIP) message sent to the MCU via a SIP router.

14. The computing device of claim 8, wherein the operations further comprise, prior to receiving the second message, determining a latency above a threshold or a loss of connectivity associated with the first communication channel.

15. The computing device of claim 8, wherein the first message includes personal identification number (PIN) data provided via a first user input, and the third message includes the PIN data via an absence of a second user input.

16. A computing device comprising:
one or more processors; and
one or more computer-readable media storing computer-executable instructions that, when executed, cause the one or more processors to perform operations comprising:
storing a client device identifier indicating that a client device associated with the client device identifier is registered to receive push messages;
receiving a Session Initiation Protocol (SIP) message including the client device identifier, a WebRTC signal gateway identifier, and an instruction to send a push message to the client device associated with the client device identifier; and
sending, to the client device and at least partly in response to receiving the SIP message, a push message including the WebRTC signal gateway identifier and an instruction for the client device to send a SIP REGISTER message to a WebRTC signal gateway associated with the WebRTC signal gateway to establish a communication channel.

17. The computing device of claim 16, wherein receiving the SIP message further comprises receiving an indication of a site outage, and sending the push message is based at least in part on the indication.

18. The computing device of claim 16, wherein the SIP message is sent to the computing device based at least in part on a stored security setting.

19. The computing device of claim 16, wherein receiving the SIP message further comprises receiving an indication of the termination event, and sending the push message is based at least in part on the indication.

20. The computing device of claim 16, wherein the instruction for the client device to send the SIP REGISTER message includes computer-executable instructions for generating the SIP REGISTER message at the client device absent a user input.
